(19) United States
(12) Patent Application Publication
(10) Pub. No.: US 2005/0078140 A1
(43) Pub. Date: Apr. 14, 2005

(54) Ink deterioration detecting device, inc deterioration detecting method, ink deterioration detecting program product, and printing control device

(75) Inventor: Satoru Ono, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/947,148

(22) Filed: Sep. 23, 2004

(30) Foreign Application Priority Data
Sep. 25, 2003 (JP) 2003-334102

(51) Int. Cl. B41J 29/38

(52) U.S. Cl. 347/19

(57) ABSTRACT

To detect deterioration of the ink used in a printing device, patches are printed based on image data for the output of certain target colors for each of the above inks, the color values of the printed patches are measured, the color values of the target colors and the measured color values are compared, and inks with differences at or over a certain level between the two, based on the results of the comparison, are determined to be inks that have deteriorated.

### BACKGROUND OF THE INVENTION

1. Field of the Invention

The present invention relates to an ink deterioration detecting device, ink deterioration detecting method, ink deterioration detecting program product, and printing control device.

2. Description of the Related Art

Printing devices normally represent a plurality of colors through a combination of various inks using cyan (C), magenta (m), yellow (Y), and black (K) or other inks such as lc (light cyan) and lm (light magenta). These colors are determined by image data generally rendered in terms of tone per color, and adjustments are commonly made at the printer manufacturing stage to ensure that a constant amount of ink is used for each color designated by a certain tone value. That is, since it is normally impossible to eliminate errors in all machines during the manufacturing of printing devices, machine errors are compensated for in advance in keeping with the coloring properties in standard machines.

During the long-term use of printing devices, meanwhile, changes occur over time, such as errors in the mechanisms for printing. Printing devices which can be calibrated to prevent such changes in output colors over time are known (such as Japanese Unexamined Patent Application (Kokai) 11-179971).

### SUMMARY OF THE INVENTION

A problem in the prior art noted above, however, is that calibration cannot be done with ink that has deteriorated. That is, the ink quantity is adjusted in the calibration so as to result in output with the same color when printing is based on the same tone values in a standard printing device and the printer being calibrated, but ink that has deteriorate does not allow adjustments to be made so as to result in output with the same color. In particular, it is completely impossible to match the coloration of a standard machine by means of calibration with inks that have under gone a change of hue due to deterioration compared to inks that have not deteriorated.

In Patent Reference 1 noted above, the colors are adjusted (calibrated) to produce a tone curve, and product deterioration is detected when errors in the tone curve are outside an acceptable range. However, calibration must be done first in order to detect such deterioration in Patent Reference 1. Calibration is generally a complicated operation, and it is pointless to perform calibrations with ink that has deteriorated so that it does not match the coloration of a standard machine. When calibration is performed, the coloration of the deteriorated ink is established as close as possible to the coloration of a standard machine, but when the ink is replaced with ink that has not deteriorated, the settings do not match the coloration of the standard machined, thus making it necessary to perform the calibrations again.

In view of the foregoing, an object of the invention is to provide an ink deterioration detecting device, ink deterioration detecting method, ink deterioration detecting program product, and printing control device allowing the deterioration of ink to be detected in order to prevent wasted calibration.

To address this object in the invention, the colors of printed results by a printing device are measured, deviation between the target colors and the results of the colorimetric measurements of the actual print are determined, and the ink is determined to have deteriorated when the difference is at or over a certain level. That is, when patches are printed based on image data for the output of certain target colors, the patches should be the same color as the certain target colors if there have been no changes over time in the printing device or no deterioration of the ink. However, the colors will be different from the target colors if the ink has deteriorated or there have been changes over time such as ejection errors in the ink ejecting mechanism. As used herein, changes over time do not include the deterioration of ink.

The invention takes note of the fact that differences at or over a certain level in relating to the target colors are produced when ink has deteriorated, regardless of whether or not there have been changes over time, measures the color of printed patches in order to determine differences, and compares them to predetermined standard target colors. As a result, when there are differences at or over a certain level, it can be determined that the ink used to print the patches has deteriorated.

As used herein, the image data referred to above is data for outputting patches in target colors. That is, the colors specified by certain image data in the printing device are shared in common, and printing devices which are adjusted prior to shipment can output target colors with virtually no differences between machines. However, as noted above, the colors will be different even when patches are output with the same image data if there have been changes over time or the ink has deteriorated. As such, although the target colors in the present specifications refer to specific colors, the colors of the actually printed patches will not necessarily be the target colors when printed with the aforementioned image data.

The target colors should provide a standard allowing the measured color values of the above patches to be evaluated. For example, patches can be printed by a certain standard printing device using image data for the output of target colors, and the colors obtained by measuring the patches can be used as the target colors. Various other arrangements can also be used, for course, predetermined color values may be set for each color of ink, and the color values may be used as standard target colors.

The color values should be obtained for the standard target colors. For example, a printer manufacturer can prepare data representing the color values, which can be produced such as by being printed on printing medium attached to the printer. Although the way the data is provided need not be limited to this, the color value comparing component should obtain the color values by retrieving such data.

The colorimetric measuring component should be able to retrieve the color values of patches. Various types of machines such as scanners or colorimetric measuring instruments can be used. Because the invention detects the deterioration of ink used in printers, it may be constructed in such a way that the calorimetric measuring component is mounted on the printer, but it may also be constructed in a way that will allow users who own calorimetric measuring instruments, scanners, or the like separate from the printer to implement the invention by using such calorimetric measuring instruments or scanners as the colorimetric measuring component of the invention.

When patches are printed, they should be printed using the functions with which printers are normally equipped. For example, each of the colored inks may be used alone, and printing may be done wit image data in which the amount of ink that is used is specified by tone value. A half tone process or the like should be done in the same manner as ordinary printed images based on the image data, and if the printer is an ink jet printer, printing structures such as the heads should be driven by producing data specifying whether or not ink for each pixel is printed. If the printer is a laser printer, mechanisms for laser irradiation or the like should be driven by producing data specifying the laser intensity for each pixel. The same should be done for other types of printers as well.

The patches that are printed should be patches allowing the measured color values and the color values of the target colors to be compared. Various types can be used. For example, patches of several target colors may be printed with image data specifying the target colors by several tone values specifying different amounts of ink. This type of arrangement allows measured color values and the color values of target colors to be compared for several colors, making it easier as a result of the comparison to determine whether or not there are differences at or over a certain level.

That is, in cases where there are no differences at or over a certain level in certain target colors but there are such differences in other target colors, erroneous determinations of no differences can be prevented. It is thus possible to ensure more reliable detection of ink deterioration. When a plurality of target colors are used, the colors should range across all possible variable areas of different ink quantities. The use of tone values stipulating different ink quantities over all the variable ink quantity areas will result in gradations for those ink colors, making it possible to more accurately verify whether or not there are any differences at or over the standard levels, from high to low brightness.

In a preferred arrangement, when comparing color values, the color values of patches printed on a standard printing device and the printer targeted for the detection of ink deterioration can be approximated with certain functions. That is, since the color values of each patch are the measured color values of patched printed based on the above image data, the color values can be matched with the tone values forming the image data, and the color values can be represented with functions in which the tone value is the variable.

When the measured color values and the color values of a plurality of target colors are plotted within a certain color space, the approximation can be done by fitting or the like using the tone values within the color space as variables to approximate the color values in the color space with the desired functions. This is approximation is used to calculate functions for approximation to the color values of patches printed on a standard printing device and functions for approximation to the color values of patches printed by the printer targeted for the detection of ink deterioration. The color values of patches printed on a standard printing device should be prepared by the provider of the printer. Data giving these function s should therefore be provided such as by being recorded on a printing medium attached to the printer. Data giving the predetermined functions should be retrieved rather than actually calculating the functions during the detection of ink deterioration.

Because these functions allow color values corresponding to any tone value to be retrieved, color values corresponding to shared tone values can be retrieved from both functions and compared to compare the color values of patched printed by a standard printing device and the printer targeted for the detection of ink deterioration. It is thus easier to determine whether or not there are differences at or over a certain standard for all tone values. Of course, patches may also be printed for all tone values for calorimetric measurement. That arrangement, however, is complicated and requires a large number of colorimetric measurement patches, whereas the use of the approximation to functions described above allows comparison of any tone value simply by measuring fewer tone values than the total of tone values.

The certain color space referred to here should allow differences in the color value to be evaluated in that color space. Various types of color space can be used, but color space that is not dependent on a machine is preferred in order to objectively evaluate the color values. In the interests of evaluating differences in color values, it is desirable to use uniform color spaces permitting the evaluation of differences in colors that are apart in the color space. More specifically, L*a*b* color space, L*u*v* color space, XYZ color space, or the like can be used. The use of such color spaces will allow differences in color values to be evaluated based on color difference.

This does not mean that such three-dimensional color spaces must be used. Color spaces that are one-dimensional, two-dimensional, or four-dimensional or more may also be used as needed. As one-dimensional or two-dimensional colors spaces, for example, some of the color components forming the three-dimensional color spaces above, such as any of hue, brightness, or color saturation, or any combination thereof, can be extracted and used to form a color space. For example, hue differences, brightness differences, color saturation differences, or differences in color component values can be evaluated and compared through a fitting process, using functions, on each of hue, brightness, color saturation, or color component value, using tone values as a variable. Evaluation is also possible by calculating color differences from the resulting hue, brightness, and color saturation differences.

A variety of functions can be used as the specific functions. Functions forming lines or curves in the color spaces may be considered, and the parameters specifying the functions color values may be calculated from the color values, or functions may be stipulated so that adjacent color values are connected by a line. When a plurality of color values are used in a fitting process of functions instead of calculating functions from just adjacent color values, the resulting functions can be considered to be functions reflecting changes in a plurality of color values, which are functions minus measurement errors in the individual color values. It is thus possible to compare color values without being affected by measurement error.

As noted above, when ink has deteriorated, calibration is pointless, and if calibration has been done, the calibrations must be done again when the ink is replaced. In another arrangement that may be employed, the fact that calibration cannot be implemented to compensate for deviations between certain standard colors and the output colors of a printer are output to a certain output device when ink deterioration is detected with a deterioration detecting component in order to avoid wasted calibration. Such an arrangement will ensure that the user can avoid wasted operations.

The concept of the invention encompasses a variety of embodiments and is capable of suitable modifications, including the use of the above ink deterioration detecting device independently, or its use in other methods while incorporated in certain machines. As to the method for detecting ink deterioration by comparing the target color with the measured results of the above patches, it may naturally be said that the invention resides, at bottom, in certain procedures according to which a process is advanced. As such, certain programs may be executed by means of a computer when realizing the invention. The invention is also applicable in the form of such program products.

Any recording medium can be used to provide such a program. Examples include magnetic recording media and opticomagnetic recording media. All recording media developed in the future can similarly be considered. The concept of the invention may also be worked in part by software and in part by hardware, and may in part be recorded on recording media and read as needed. The same is true of stages of reproduction, whether primary or secondary reproductions, etc. The invention can also be provided in the form of an auxiliary function of a printing control device for printing based upon image data.

### BRIEF DESCRIPTION OF THE DRAWINGS

FIG. 1 is a block diagram illustrating the general structure of a printing control device.

FIG. 2 is an illustration of a patch that is printed.

FIG. 3 is a projected figure of color values projected on the a*b* plane.

FIG. 4 is an illustration of an example of a tone curve.

FIG. 5 is a flow chart of a calibration process.

FIG. 6 illustrates the fitting of an L* value.

FIG. 7 illustrates the fitting of an a* value.

FIG. 8 illustrates the fitting of a b* value.

### DESCRIPTION OF THE PREFERRED EMBODIMENTS

Embodiments of the invention are illustrated in the following order.

### (1) Structure of Printing Control Device

(1-1) Calibration Process

(1-2) Detection of Ink Deterioration

### (2) Other Embodiments

### (1) Structure of Printing Control Device

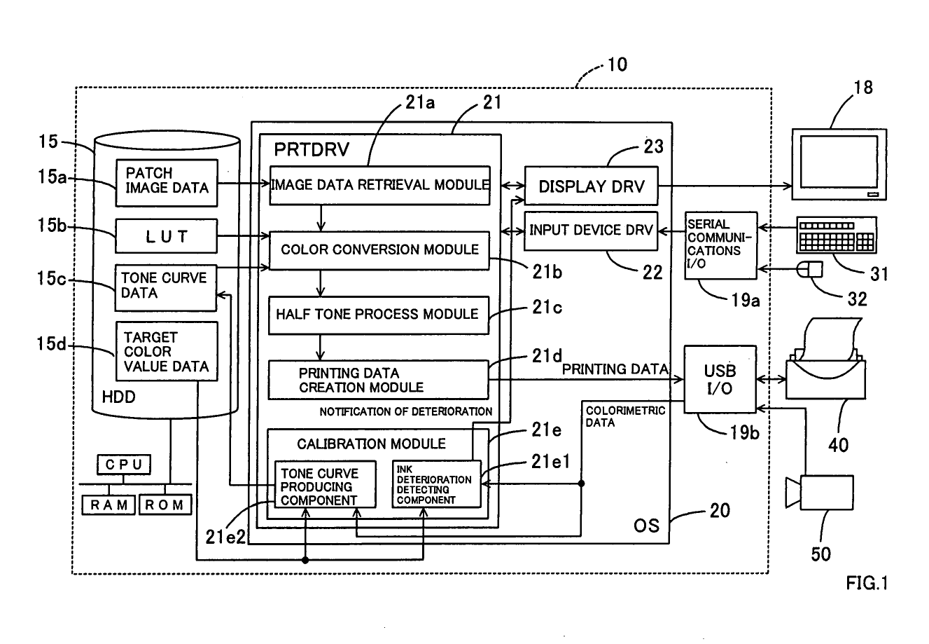

FIG. 1 is a block diagram illustrating the general structure of a computer serving as a printing control device in the invention. The computer 10 comprises a CPU which acts as the center of computer processing, and memory media such as ROM or RAM, and can run certain programs while using peripheral devices such as an HDD 15. Operating input devices such as a keyboard 31 and mouse 32 are connected by a serial communications I/O 19a, and a display 18 is also connected by a video board (not shown). It is also connected by a USB I/O 19b to a printer 40.

A calorimetric measuring device 50 is also connected by the USB I/O 19b. The printer 40 in the present embodiment comprises a mechanism permitting the attachment and detachment of ink cartridges filled with various colored inks. Cartridges for CMYKlclm inks are mounted on this mechanism. The printer 40 can combine these ink colors to form numerous colors, thereby forming color images on a printing medium. The printer 40 in this embodiment is an ink jet type of printer, but various other types of printers such as laser printers can be used in the invention in addition to ink jet printers. That is, the invention includes various types of color agents, such as toner ink.

The use of the six colors of CMYKlclm is not necessary. The four colors of CMYK or seven colors of CMYKlclmDY (direct yellow) may also be used. Other colors such as R (red) and V (violet) may also be used, of course, instead of lc and lm inks, and gray ink may be used for the K ink. With the calorimetric measuring device 50, the printed material is irradiated with a light source of known spectral reflectance, the reflected light is detected to detect the spectral reflectance of the printed material, and the color values such as L*a*b* or XYZ values can be output. In this embodiment, the L*a*b* of patches printed by the printer 40 are measured.

A simplified description of the computer 10 will be given. One with the common structure of a personal computer may be used. Computers to which the invention is applicable are not limited to personal computers, of course. Although what is referred to as a desk top computer is used in the embodiment, lap tops and portable types may also be used. In addition, the interface connecting the computer 10 and printer 40 need not be limited to the above. Various types of connecting embodiments such as parallel interfaces, SCSI connections, and wireless connections can also be used, as well as any connecting embodiments developed in the future.

The printing control device in this embodiment is constructed with a computer 10, but the printing control process in the invention can also be worked by a program executing environment installed on a printer. The printing control process can also be implemented by obtaining image data from a digital camera directly connected to the printer 40. Of course, a variety of other arrangements can also be used, such as implementing the printing control process with a digital camera in similar structures, and implementing the printing control process of the invention by a decentralized process. The printing control process of the invention may also be done with composite devices comprising integrated scanners for retrieving images and printers for printing images.

In the computer 10 in this embodiment, a printer driver (PRT DRV) 21, input device driver (DRV) 22, and display driver (DRV) 23 are incorporated in the OS 20. The display DRV 23 is a driver for controlling the display such as a printer property screen or image to be printed on the display 18, and the input device DRV 22 is a driver for receiving certain input operations upon receipt of code signals from the mouse 32 or keyboard 31 input via the serial communications I/O 19a.

The PRT DRV 21 can execute printing through a certain process on patch images described below or images for which a printing command has been executed from an application program (not shown). The PRT DRV 21 comprises an image data retrieval module 21a, color conversion module 21b, half tone process module 21c, and printing data creation module 21d, for implementing printing. When a printing command is given, the PRT DRV 21 is driven, and the PRT DRV 21 transfers data to the display DRV 23, which displays a UI (not shown) for inputting commands to implement calibration operations or data indicating printing conditions such as the print medium, image quality, and printing speed.

The user uses the keyboard 31, mouse 32, or the like to input the data needed for printing on the UI, and when a calibration command is given, the various PRT DRV 21 modules are activated, the various image data processes are executed by the modules on the above image data, and printing data is produced. The printing data that has been produced is output via the USB I/O 19b to the printer 40, and the printer 40 executes the printing process based on the printing data.

More specifically, the image data retrieval module 21a retrieves image data for showing patch images described below or images for which a printing command has been executed by an application program as noted above. If the number of pixels in the image data is too little or too much at that time, a resolution conversion process is implemented to ensure the pixels needed for printing. This image data is dot matrix data stipulating the color of each pixel through the tone representation of RGB (red, green, blue) color components, which in this embodiment is 256 tone for each color, and employs a color system in accordance with sRGB standards.

This data is used as an example in this embodiment, but various other types of data, such as JPEG image data using the YCbCr color system or image data using the CMYK color system, can also be used. Of course, the invention is also applicable to data based on the Exif 2.2 standard (Exif is a registered trademark of the Japan Electronics and Information Technology Industries Association), data corresponding to Print Image Matching (PIM; PIM is a registered trademark of Seiko Epson), and the like.

The color conversion module 21b is a module for converting the color system showing the colors of each pixel. The sRGB color system of the image data is converted to the CMYKlclm color system, the components of which are the inks (CMYKlclm) installed in the printer, with reference to an LUT (color conversion table) 15b stored on the HDD 15. The LUT 15b is a table that represents colors by means of both the sRGB color system and the CMYKlclm color system, matches the two, and describes the correspondence between them for a plurality of colors. The colors of the CMYKlclm color system corresponding to any color represented in the sRGB color system can thus be calculated through interpolation by referencing the sRGB colors, which are surrounding colors, stipulated in the LUT 15b, enabling color conversion.

The CMYKlclm color system data is image data in which each of the CMYKlclm colors is represented by a tone of 256, where each tone value corresponds to an amount of each color of ink. The amount of ink for each tone value is predetermined, stipulating tone values so that an ink recording rate of 0 to 100% per unit area corresponds in linear fashion to tone values of 0 to 255, for example. The half tone processing module 21c converts the numbers of tone to come up with the amount of ink corresponding to each tone value.

Even when the amount of ink for each tone value of CMYKlclm is determined in the manner described above, the amount of ink corresponding to the predetermined tone value will not always be properly output, due to manufacturing errors and the like in the machine parts of the printer 40. The printer 40 in this embodiment is thus equipped with a mechanism for compensating for such errors. That is, tone curve data 15c for correcting the tone values of each color is stored on the HDD 15, and the color conversion module 21b references this tone curve data 15c to correct the CMYKlclm tone values after conversion with the LUT 15b.

In this embodiment, before the printer 40 is shipped, the manufacturer of the printer 40 prepares tone curve data 15c to ensure compliance with the output colors of a certain standard printer, and the data is stored on the HDD 15. The user of the printer 40 can also perform calibrations to produce the tone curve data 15c. The calibration process is described in detail below.

When CMYKlclm data is obtained after color conversion by the color conversion module 21b, the half tone process module 21c converts the tone values of each pixel represented by the CMYKlclm color system to half tone image data stipulating whether or not ink is ejected for each pixel. That is, it determines whether or not the printer ejects ink droplets for each pixel. Of course, the amount of ink ejected may be controlled in a stepwise manner, and the size of the ejected ink droplets may be determined, in addition to whether or not ink droplets are ejected.

The printing data creation module 21d receives the half tone image data, arranges the data in the sequence used by the printer 40, and sequentially outputs units of data used per main scan to the printer 40. That is, the printer 40 is equipped with an ejection nozzle array as the ink ejection device. Because a plurality of ejecting nozzles are arranged in nozzle arrays in the subscanning direction, data that is several dots apart in the subscanning direction can be used simultaneously.

Among the data arranged in the main scanning direction, that which is to be used simultaneously is arranged in sequence so as to be buffered simultaneously by the printer 40. The printing data creation module 21d adds certain data such as the image resolution to the arranged data to produce printing data, which is output through the USB I/O 19b to the printer 40. Upon the transmission of all data needed for the printer 40 to form images, the images are formed on a printing medium by the printer 40.

(1-1) Calibration Process

The calibration process noted above is described in detail below. The PRT DRV 21 is equipped with a calibration module 21e. The calibration module 21e can be activated by a calibration command from the printer property screen. The calibration module 21e is equipped with an ink deterioration detector 21e1 and a tone curve preparing component 21e2. The tone curve preparing component 21e2 runs a process for preparing tone curve data 15c, and executes printing based on the patch print data 15a in response to the above calibration command.

In the present embodiment, the patch image data 15a represents patches for running a calibration process and the ink deterioration detection process described below, and is composed of tone values obtained when tone values are changed at a constant breadth over the entire range for each ink color. In the example in this embodiment, the tone values of ink colors are changed in increments of 7 (7, 14, . . . 252). Patches of a certain area are printed, where tone values other than that ink color are 0.

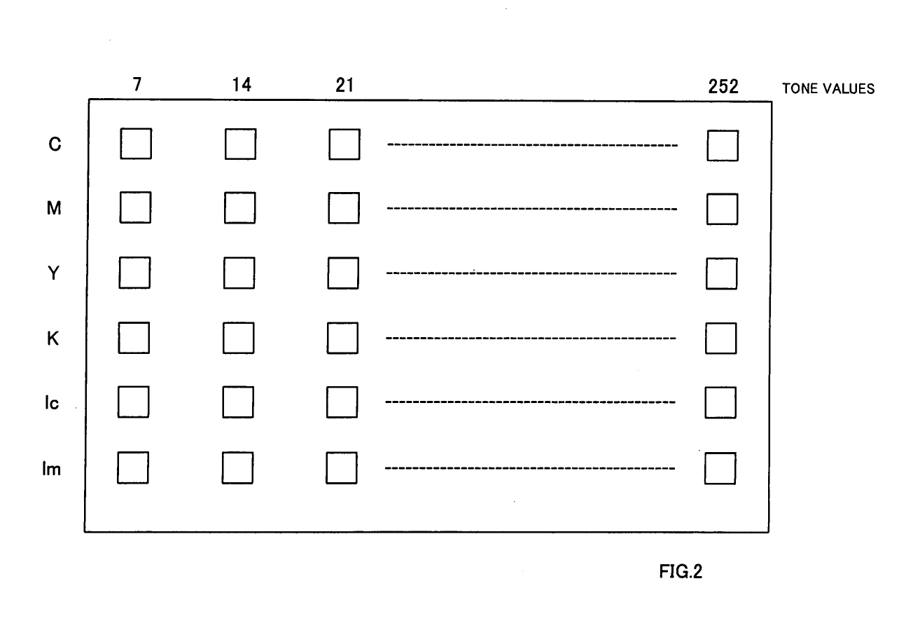

In this patch image data 15a, the tone values are changes as described above for each of the CMYKlclm colors to come up with image data for printing patches. The image data retrieval module 21a, color conversion module 21b, half tone process module 21c, and printing data creation module 21d execute the above processes to print a plurality of patches as illustrated in FIG. 2. In that figure, the printing medium is indicated by a large rectangle. Tone values are indicated at the top side, and ink colors are indicated at the left side. As the tone value increases, the amount of ink increases. The patches shown in the figure are thus lighter on the left side and become increasingly dark moving toward the right.

In this embodiment, as noted above, the manufacturer of the printer 40 prepared a tone curve prior to shipping the printer 40 to ensure compliance with the colors output by a certain standard printer. The colors of the patches should therefore be consistent with the output of the standard printer as long as there have been no changes over time in the printer 40 or any ink deterioration. That is, the patch image data 15a corresponds to image data for the output of target colors in the above claims.

When changes over time result in ejection errors in the ink ejection mechanism, the patch colors will not be consistent with the colors output by the standard printer. The calibration process makes them consistent. The above patches are calorimetrically measured with a colorimetric device 50 for that process. The tone curve preparing component 21e2 retrieves calorimetric data showing the results of the measurement via the USB I/O 19b, and renews the tone curve data 15c to obtain generally the same color output as the color output by the standard printer based on the patch image data 15a.

Based on the patch image data 15a, the calorimetric results for the patches output by the standard printer are prepared in the form of target color value data 15d, which is stored on the HDD 15. The tone curve preparing component 21e2 prepares a tone curve by interpolation based on the colorimetric data obtained through the USB I/O 19b and the target color value data 15d.

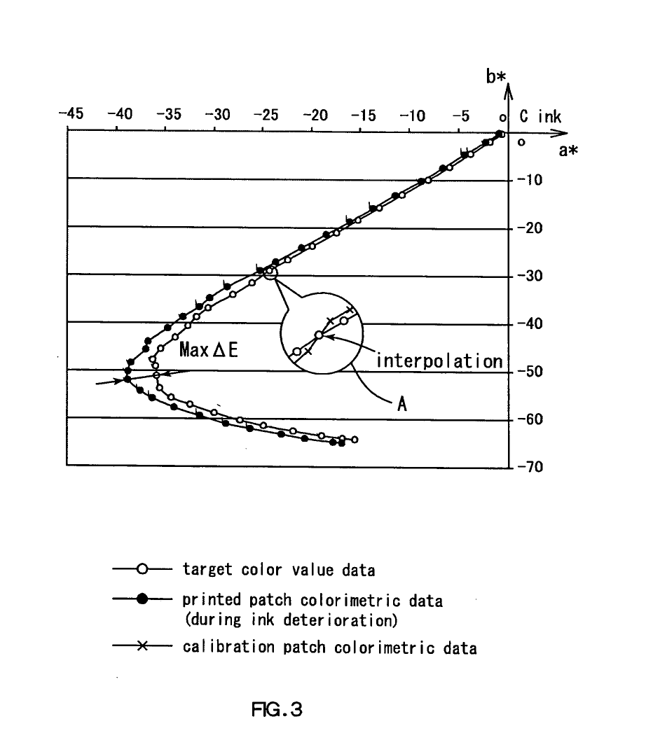

FIG. 3 illustrates the process during the preparation of a tone curve. In the figure, the horizontal axis is the a* value for L*a*b* color space, and the vertical axis is the b* value. That is, the L*a*b* values in L*a*b* color space, which is a three-dimensional color space, are projected on the a*b* plane.

The figure shows an example of the plotted color values for C ink. The white circles in the figure are the projected values of the target color value data 15d, and are color values corresponding to tone values 7, 14, . . . 252 in linear order starting from the white circle near the starting point 0. When the colorimetric values of the patches printed as shown in FIG. 2 are plotted on the graph in FIG. 3, they are arranged near the color values shown by the white circles. The color values of the white circles are interpolated using the colorimetric values of the printed patches near the white circles when no ink deterioration described below is detected (when calibration will not be done in vain).

The detail represented by A in FIG. 3 shows the calorimetric results for printed patches such as in FIG. 2 when plotted by ×. In the figure, the white circles are the calorimetric values of the results printed by a standard printer using patch image data 15a, and the ×'s are the colorimetric values of the results printed by the printer 40 using the patch image data 15a. The user measures these with the colorimetric device 50. As illustrated in the detail, the color values deviate from each other, despite the original patch image data 15a shared in common.

It is possible to calculate the tone values for outputting colors with the printer 40 that are generally the same as the target colors of the standard printer when tone values allowing generally the same color values as the white circles to be printed by the printer 40 are interpolated from the locations of the surrounding ×'s. The interpolation involves calculating the tone values which will allow the printer 40 to output the colors output by the standard printer at tone values of 7, 14, . . . 252, so that a tone curve can be prepared by the printer 40 using the calculated tone values as output values and the aforementioned tone values 7, 14, . . . 252 as input values.

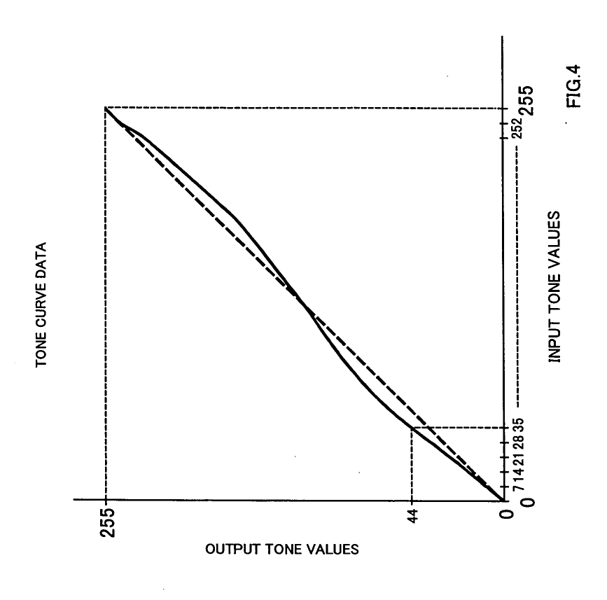

FIG. 4 illustrates an example of a tone curve. In the figure, the horizontal axis represents the input tone values, and the vertical axis represents the output tone values. The dashed line on the graph represents the input and output properties when the input values are not converted. The curve represented by the solid line illustrates an example of the input and output properties of the prepared tone curve. That is, in the example illustrated in FIG. 4, when the tone value converted by the color conversion module 21b is 35, the value is corrected to a tone value of 44. This tone value of 44 is the tone value allowing the printer 40 to output generally the same color as a tone of 35 by the standard printer.

The above tone curve can be used for calibration. That is, tone values can be corrected by referencing the tone curve and using the tone values converted by the color conversion module 21b as input values, and the corrected image data can be input to the half tone process module 21c to obtain the same output colors as the standard printer. In the above calibration, the output values are calculated by interpolation of discrete tone values 7, 14, . . . 252, but of course output values between these levels can be calculated by interpolation or the like. The interpolation may be done during the conversion by the color conversion module 21b or in advance.

In FIG. 3, a description was given on the a*b* plane for the sake of simplicity, but the process is actually done in three-dimensional L*a*b* color space. Of course, when the focus is on matching the colors to certain color component values, interpolation can be done in one- or two-dimensional color space instead of three-dimensional color space. For example, when the focus is on matching brightness, tone values allowing the printer 40 to produce generally the same brightness as the standard printer may be calculated by interpolation, and when the emphasis is on hue or color saturation, the interpolation should result in generally the same hue or saturation in the a*b* plane.

(1-2) Detection of Ink Deterioration

The above calibration allows the colors output by the printer 40 to be close to the colors output by a standard printer by eliminating cases where the ink has deteriorated, correcting errors or the like caused by changes over time, and so forth. However, when ink has deteriorated, no calibration process is capable of correcting errors and the like caused by changes over time or the like. The black circles in FIG. 3 are a plot of the calorimetric values when a plurality of patches have been printed with ink that has deteriorated.

In the example in the figure, the output properties have changed as a result of the deterioration (such as oxidation or precipitation of colorant) of the ink, and the hue deviates in a constant direction with respect to the target colors across all tone values. When deviations in hue are produced in such a constant direction and are outside the permissible range, a tone curve 15c cannot be prepared by interpolation as described above. That is, the color values on the solid line connecting the black circles shown in FIG. 3 would be calculated through interpolation, and it would therefore be impossible to interpolate color values that are not on the line.

Of course, when the line connecting the black circle sis extremely close to the line connecting the white circles, it would be possible to calculate tone values for outputting colors generally the same as the white circles in the form of approximate values. However, when the deviation in hue is outside the permissible range, it will not be possible to correct the output colors by calibration. Thus, prior to calibration in this embodiment, it is determined whether or not the ink has deteriorated, and it the ink has deteriorated, that fact is communicated, and no calibration is performed.

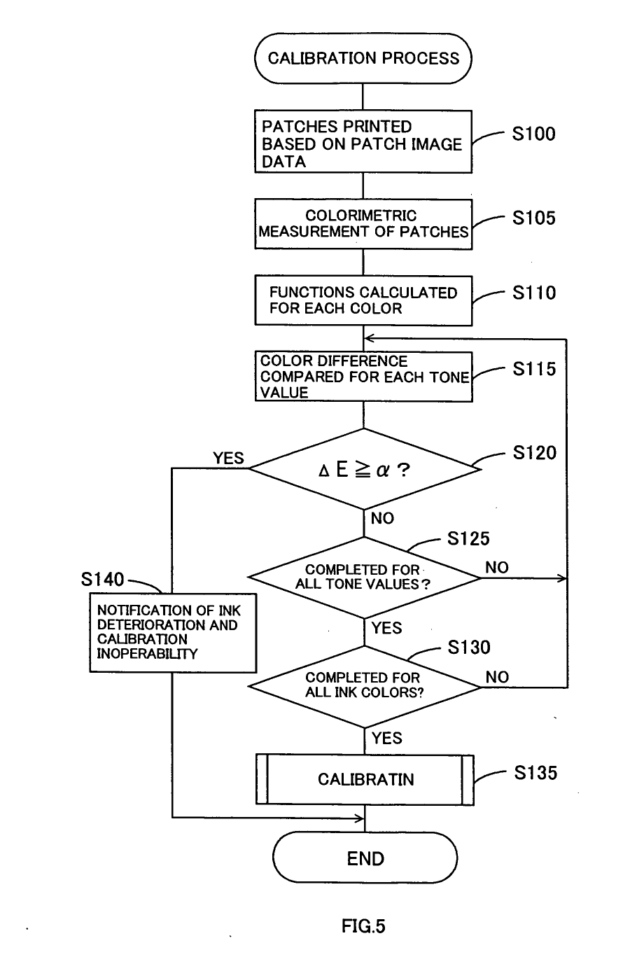

In order to ascertain whether or not the deviation in hue is outside the permissible range in the present embodiment, the L*a*b* values of patches printed with the same tone values are compared in sequence to determine whether or not any color difference ΔE is over a certain maximum value. FIG. 5 is a flow chart of a calibration process, with the details of the determination process. The process for detecting whether or not ink has deteriorated is performed before the calibration in Step S135 in the flow chart. First, in Step S100, the patch image data 15a is processed by the image data retrieval module 21a, color conversion module 21b, half tone process module 21c, and printing data creation module 21d, and the plurality of patches illustrated in FIG. 2 are printed. The process in Step S100 thus corresponds to the process by the patch printing component.

In Step S105, the plurality of patches are colorimetrically measured by the colorimetric device 50, and the ink deterioration detecting component 21e1 retrieves the calorimetric data giving the results. The process in Step S105 corresponds to the process by the calorimetric component. The colorimetric data is stored in memory (not shown), and when no ink deterioration is detected, the tone curve preparing component 21e2 references the calorimetric data. In Step S110, the L*a*b* color component values are fitted to higher order functions based on the calorimetric data that has been retrieved. Functions in which the variable is the tone value per color component are stipulated at this time.

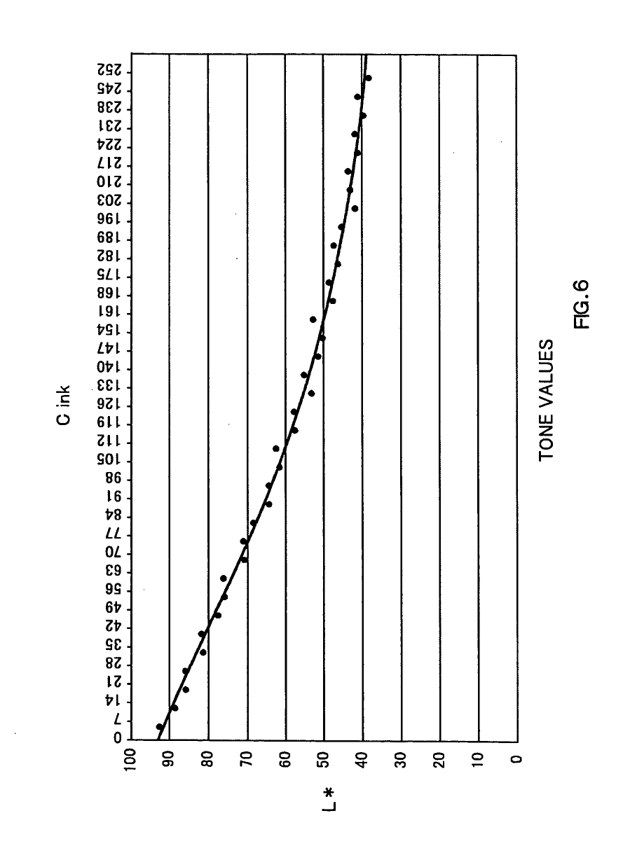

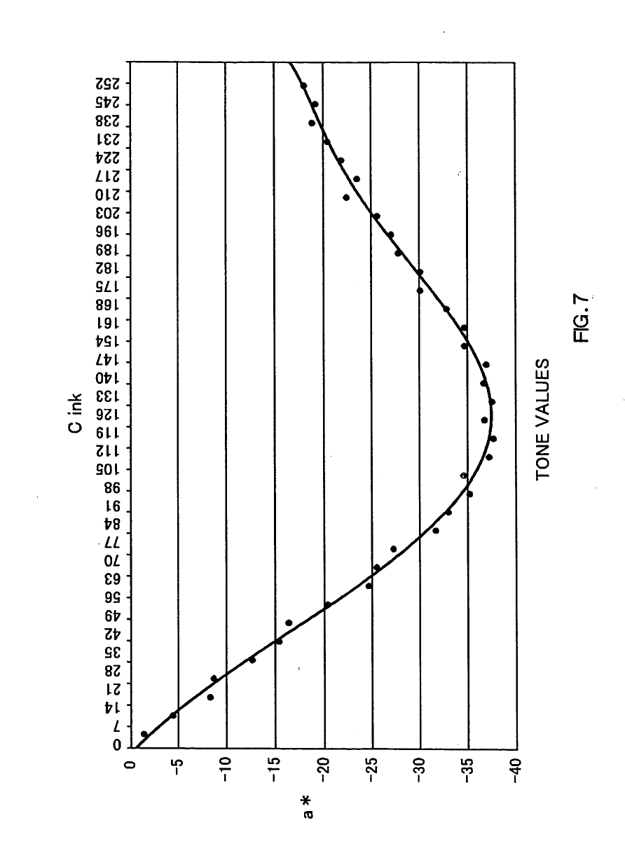

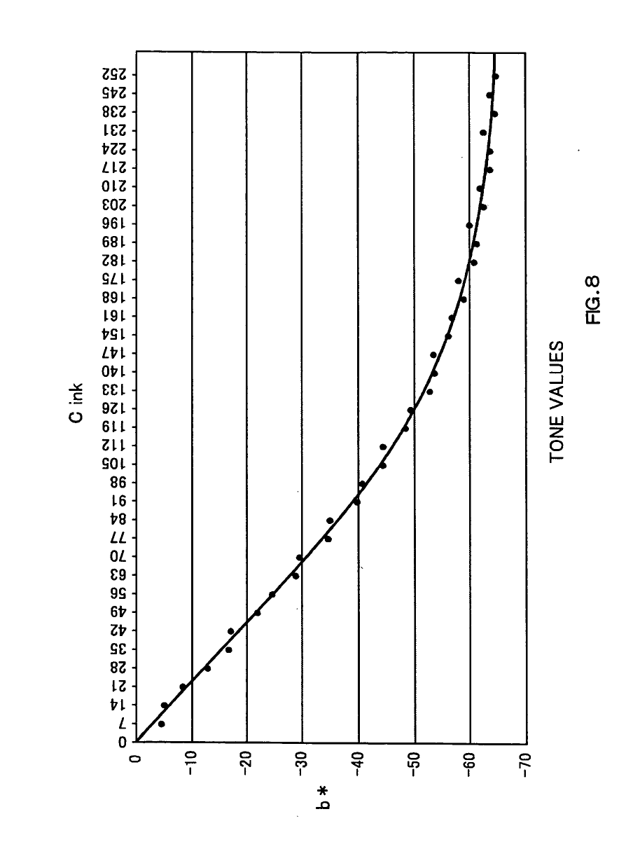

FIGS. 6 through 8 illustrate fitting processes of L* values, a* values, and b* values. In these figures, the horizontal axis represents tone values, and the vertical axes represent L* values, a* values, and b* values. The L* values, a* values, and b* values corresponding to tone values 7, 14, . . . 252 are ascertained by the colorimetry in Step S105 above.

In FIGS. 6 through 8, the L* values, a* values, and b* values determined from them for C ink are plotted by black circles. When a plurality of L* values, a* values, and b* values for tone values have been obtained, the coefficient of the functions can be calculated from the L*a*b* values, assuming higher order functions in which the tone value is the variable. It is thus possible to determine functions describing the L*a*b* values using the tone value as the variable.

Of course, here, it should be possible to describe the L*a*b* values in relation to tone values. The order or form of the function is not limited. Certain functions in which the tone value in L*a*b* color space may also be stipulated instead of calculating functions that individually describe L* values, a* values, and b* values. The values of the black circles in FIG. 6 through 8 can include calorimetric errors or the like, but the functions can be calculated as described above to determine L* values, a* values, and b* values in such a way as to result in smooth changes across the entire range of tone values, eliminating the effect of colorimetric errors or the like.

When functions are determined in the manner noted above, since the L*a*b* values corresponding to each tone value can be calculated, the aforementioned ink deterioration detecting component 21e1 retrieves the target color value data 15d in Step S115. Because the target color value data 15d gives the color values corresponding to tone values 7, 14, . . . 252, it is possible to ascertain the L*a*b* values of the target colors serving as the basis for tone values 7, 14, . . . 252.

A tone value is thus extracted from tone values 7, 14, . . . 252, and the L*a*b* values of the calorimetrically measured patches described above are calculated by substitution into the calculated function. L*a*b* values of the target colors corresponding to the extracted tone values are thus obtained based on the target color value data 15d. The difference in color values corresponding to the tone values is thus calculated from those values and compared to determine whether or not the color difference is at or over a certain value α in Step S120.

This value α is the color difference showing the permissible range. For example, a value of about 2 to 3 in ink jet printers can avoid wasted calibration. That is, a color difference of that magnitude indicates ink deterioration, regardless of the presence or absence of changes over time, and will ensure that no calibration is performed. The comparative process in Step S115 thus corresponds to the process by the color value comparing component, and the determination in Step S120 corresponds to the process by the ink deterioration detecting component. In Step S120, when it is not determined that the color differences is at or over the certain value α, it is determined whether or not a determination has been made in Step S120 for all of the tone values 7, 14, . . . 252.

When it is determined in Step S125 that a determination has not been made in Step S120 for all of the tone values 7, 14, . . . 252, the process is repeated from Step S115 on tone values which have not been determined. When it is determined in Step S125 that a determination has been made in Step S120 for all of the tone values 7, 14, . . . 252, it is determined in Step S130 whether or not the process from Step S115 has been concluded for all colors of ink used in the printer 40. When it is determined in Step S130 that the process from Step S115 has not been concluded for all colors of ink used in the printer 40, the process is repeated from Step S115 on different colors of ink.

When it is determined in Step S130 that the process from Step S115 has been concluded for all colors of ink used in the printer 40, since none of the ink has deteriorated, the process by the tone curve producing component 21e2 is performed in Step S135 and calibration is performed. When, on the other hand, it is determined that the color difference is at or over value α in Step S120, the output color cannot be matched with that of the standard printer even if calibration is performed.

Thus, in Step S140, certain control data is output to the display DRV 23 so that the display 18 displays ink deterioration, communicating the ink deterioration to the user. In this embodiment, a message can also be displayed that calibration cannot be performed because of ink deterioration, thus communicating that calibration cannot be performed. The calibration process is thus concluded. In this case, the user will not have performed the calibration process in vain, and can take measures such as replacing the ink without unnecessary processing. The process in Step S140 thus corresponds to the process by the inoperability output component.

That is, it has been explained that when calibrations are performed in the absence of any notification of ink deterioration, it will be ascertained for the first time that colors do not match the colors output by a standard printer when images are printed after such calibration. Such calibrations are completely useless. In the present invention, however, the user is notified of ink deterioration, and can take appropriate measures such as replacing the ink without such wasted procedures. In the embodiment above, color differences were compared for some of the tone values among all 256 tone values, but all of the tone values may also be determined. In such cases, data on all the tone values can be prepared as the target color value data 15d, or a fitting process or the like of the aforementioned functions may be used based on the prepared color values to calculate target color values corresponding to all of the tone values.

### (2) Other Embodiments

In the above embodiment, the deterioration of ink was detected by determining whether or not the colorimetric values for a plurality of patches used to detect ink deterioration had differences at or over a certain standard in relation to standard target colors, but other arrangements may also be used, of course. For example, when the colorimetric results of the patches are compared with the standard target colors, differences in hue, brightness, or color saturation can be calculated instead of color differences. Particularly when there are differences in hue in a constant direction relative to the target colors over the entire range of tone values due to ink deterioration, as in FIG. 3, the differences in hue can be calculated to detect ink deterioration.

In the calibration in the above embodiment, adjustments were made by correcting the tone values at the monochromatic level so as to match the color output that was output monochromatically by a standard printer, but the present invention is not limited to this calibration. For example, the invention is applicable to types of calibrations in which the color balance is adjusted by taking into consideration combinations of a plurality of colors. That is, the invention is also applicable to arrangements in which patches for printing gray and patches in which the tone values are slightly altered from the tone values for printing gray are printed, and the balance of the amounts of ink is adjusted based on colors that look the closest to gray.

In this case as well, calibration can be performed despite slight errors resulting from changes over time, but calibration cannot be performed, and will be pointless, when deviations caused by ink deterioration are over the permissible range. When, for example, deviations in hue caused by such deterioration are outside the permissible range, such as the ink shown in FIG. 5, few colors can be expressed on the side opposite the deviation side, even when combined with inks of other colors. That is, the range in which colors can be represented by the printer 40 is narrow than the standard printer.

When such changes in color area are over the permissible range, the colors cannot match the colors output by the standard printer, despite calibration. Even if calibration is performed, the differences will be greater between locations that are and are not subject to substantial compression during compression of the color areas, resulting in defects such as excessive bleeding of colors. A process for detecting ink deterioration is thus performed before such calibrations in the invention, and when deterioration is detected, no calibration is performed, thereby allowing wasted operations from being carried out.

The calibration is not necessarily limited to tone curves for correcting tone values that have undergone color conversion. Various other arrangements can also be employed. For example, corrections can be made so that the amounts of ink used are increased uniformly, making it far easier to perform the calibrations.

The patches for comparison with target colors are not limited to those described above. For example, tone values resulting in the greatest color difference due to ink deterioration can be determined in advance, and the color output by the standard printer may be compared to the printer 40 at those tone values or numerous points around those tone values. Such an arrangement allows ink deterioration to be effectively detected with fewer measured colors. The structure for running programs is also not limited to general purpose processors such as CPU's. Various other embodiments, such as custom IC's, can also be employed.

1. An ink deterioration detecting device for detecting deterioration of ink used in printing devices, comprising:
a patch printing component for printing patches based on image data for the output of certain target colors for each of the above ink colors;
a calorimetric component for measuring the color values of the printed patches;
a color value comparing component for comparing the color values of the target colors and the measured color values; and
a deterioration detector for determining, on the basis of the compared results, that inks with a difference over a standard level between the two are inks that have deteriorated.

2. An ink deterioration detecting device according to claim 1, wherein the image data is data in which the target colors of each patch are specified by a plurality of tone values designating different ink quantities.

3. An ink deterioration detecting device according to claim 1, wherein the color values of the target colors are obtained by measuring a plurality of patches printed by a certain standard printing device with image data for outputting the target colors.

4. An ink deterioration detecting device according to claim 3, wherein the color value comparing component allows the measured color values of a plurality of patches printed by means of image data for outputting the target colors on a printing device having ink targeted for deterioration detection and the standard printing device to be approximated with certain functions within a certain color space, and calculates the color values corresponding to shared tone values based on the functions so as to compare them.

5. An ink deterioration detecting device according to claim 4, wherein the color value comparing component calculates the color difference based on the color values, and the deterioration detecting device determines the ink to have deteriorated when the color difference is at or over a certain color difference.

6. An ink deterioration detecting device according to claim 1, wherein the color value comparing component compares any one or combination of hue differences, brightness differences, color saturation differences color componet differences, and color differences.

7. An ink deterioration detecting device according to claim 1, comprising an inoperability output component for outputting to a certain output device the fact that calibration intended to compensate for deviation between a certain standard color and the color output by the printing device cannot be performed when ink that has deteriorated is detected by the deterioration detection component.

8. An ink deterioration detecting method for detecting deterioration of ink used in printing devices, comprising the steps of:
printing patches based on image data for the output of certain target colors for each of the above ink colors;
measuring the color values of the printed patches;
comparing the color values of the target colors and the measured color values; and
determining, on the basis of the compared results, that inks with a difference over a standard level between the two are inks that have deteriorated.

9. An ink deterioration detecting program product allowing a computer to execute the functions of:
printing patches based on image data for the output of certain target colors for each of the above ink colors;
retrieving the calorimetric measurement data that results upon the measurement of the color values of the printed patches by a colorimetric measuring device;
comparing the two color values based on target color value data representing the color values of the target colors printed on a certain printing medium and the calorimetric measurement data representing the measured color values; and
determining, on the basis of the compared results, that inks with a difference over a standard level between the two are inks that have deteriorated.

10. A printing control device for retrieving image data that represents printing target colors so as to control their printing, and for detecting the deterioration of ink used in the printing device, comprising:
a patch printing component for printing patches based on image data for the output of certain target colors for each of the above ink colors;
a colorimetric measurement data retrieval component for retrieving the colorimetric measurement data that results upon the measurement of the color values of the printed patches by a colorimetric measuring device;
a printing medium on which is printed the target color value data representing the color value of the target colors;
a color value comparing component for comparing the color values of the target colors represented by the target color value data and the color values represented by the colorimetric measurement data;
a deterioration detection component for determining, on the basis of the compared results, that inks with a difference over a standard level between the two are inks that have deteriorated; and
an ink deterioration output component for outputting a message that the ink has deteriorated to a certain output device.
